(19) United States
(12) Patent Application Publication
(10) Pub. No.: US 2014/0272188 A1
(43) Pub. Date: Sep. 18, 2014

(54) ANTI-FRICTION COATING TO PISTON ASSEMBLY

(71) Applicant: Mahle International GmbH, Stuttgart (DE)

(72) Inventors: Reinhard Rose, Stuttgart (DE); Volker Weisse, Stuttgart (DE); Dobua Cedric, Stuttgart (DE); Zeynep Kara, Stuttgart (DE)

(73) Assignee: Mahle International GmbH, Stuttgart (DE)

(21) Appl. No.: 14/213,427

(22) Filed: Mar. 14, 2014

Related U.S. Application Data
(60) Provisional application No. 61/794,459, filed on Mar. 15, 2013.

(51) Int. Cl. F02F 3/10

(52) U.S. Cl. CPC F02F 3/10
USPC 427/543; 427/532; 427/553

(57) ABSTRACT

A method of applying an anti-friction coating to a piston assembly is provided including applying an anti-friction coating to at least a portion of the surface area of a piston. The anti-friction coating comprises a binder matrix and a solid lubricant. A localized curing energy is applied to only a portion of the surface area. The localized curing energy comprises a first curing energy.

### CROSS-REFERENCE TO RELATED APPLICATIONS

This application claims priority to U.S. Provisional Patent Application No. 61/794,459, filed Mar. 15, 2013, the contents of which are hereby incorporated in its entirety.

### FIELD OF THE INVENTION

Some embodiments relate to the application of anti-friction resistance coatings in mechanical systems and apparatus.

### BACKGROUND

It is known that moving parts in mechanical systems can be subjected to frictional forces. As a non-limiting example, during normal operation, the pistons in internal combustion engines are subjected to frictional forces. The face of the piston is often in direct contact with a cylinder wall of a bore receiving the piston. During normal engine operation, the piston movement within the bore occasionally removes the lubricating film from the cylinder wall. The removal of the lubricating oil film results in detrimental metal to metal contact and accelerated wear.

As internal combustion engines achieve increasingly higher performance, higher power, and higher operating stresses, the piston must have excellent wear and scuff resistance. A commonly known problem with many pistons and their components is that they are not sufficiently resistant to wear. Outer surfaces of mechanical parts, including but not limited to, pistons of internal combustions engines, are often coated to improve performance characteristics of the parts, e.g., by altering frictional properties or wear characteristics of the surfaces. Increased wear resistance has been achieved by coating the various piston components with a material known to possess improved wear resistance.

However, many current processes for applying these coatings are expensive, consume large amounts of energy, and/or generate significant waste. For at least these reasons, an unmet need remains for improved systems, methods, compositions, and apparatus for creating wear-resistant articles that are more economical and energy-efficient, have shorter cycle time, and are less wasteful.

### BRIEF DESCRIPTION OF THE DRAWINGS

The various features of the exemplary embodiments illustrated and described with reference to any one of the figures may be combined with features illustrated in one or more other figures, as an appropriate artisan will understand. Alternative approaches that may not be explicitly illustrated or described may be able to be produced. The combinations of features illustrated provide representative illustrations for one or more possible applications. However, various combinations and modifications of the features consistent with the teachings of the present disclosure may be desired for particular uses or implementations.

FIG. 1 comprises an exemplary illustration of a piston assembly.

FIG. 2 comprises an exemplary illustration of a spray application of an anti-friction coating to a piston assembly.

FIG. 3 comprises an exemplary illustration of a silk screening application of an anti-friction coating to a piston assembly.

FIG. 4 comprises an exemplary illustration of an infra-red radiation curing of the anti-friction coating on a piston assembly.

FIG. 5 comprises an exemplary illustration of an ultra-violet radiation curing of the anti-friction coating on a piston assembly.

FIG. 6 comprises an exemplary illustration of an induction curing of the anti-friction coating on a piston assembly.

### DETAILED DESCRIPTION

Illustrative examples are shown in the appended drawings. Although the drawings represent the exemplary illustrations described herein, the drawings are not necessarily to scale and certain features may be exaggerated to better illustrate and explain an innovative aspect of an exemplary illustration. Further, the exemplary illustrations described herein are not intended to be exhaustive or otherwise limiting or restricting to the precise form and configuration shown in the drawings and disclosed in the following detailed description.

Reference in the specification to “an exemplary illustration”, an “example” or similar language means that a particular feature, structure, or characteristic described in connection with the exemplary approach is included in at least one illustration. The appearances of the phrase “in an illustration” or similar type language in various places in the specification are not necessarily all referring to the same illustration or example.

Exemplary illustrations are provided herein of a method of applying an anti-friction coating on a surface, where the coating is produced by applying an anti-friction coating material to the surface and curing the material by applying localized curing energy such as infra-red radiation, ultra-violet radiation, or induction radiation. In some approaches, the coating is applied before curing via a spray application or a silkscreen method. The coating is useful for producing high wear-resistant properties on the contacting friction surfaces of machined component parts including but not limited to, pistons and related components, piston connecting rods, cylinder liners, and other direct contact, wear prone surfaces.

Referring now to FIG. 1, which is an exemplary illustration of a part assembly 10 depicted as a piston assembly. The piston assembly 10 may include a piston 12 having a piston crown 14, or “land,” and a piston skirt 16. The piston crown 14 may include a plurality of piston grooves 18 formed about its outer peripheral surface configured to receive corresponding piston rings and thereby to seal against a cylinder wall of an engine bore. The piston skirt 16 is generally configured to support the piston crown 14 during engine operation by interfacing with corresponding surfaces of the cylinder wall to stabilize the piston during reciprocal motion within the bore.

An exemplary connecting rod 20 may include a piston pin end or small end 22 and a crankshaft end or large end 24. The piston pin end 22 may include a piston pin bore 26 that defines a piston pin bore surface 28. The crankshaft end may 24 include a crankshaft pin bore 30 that defines a crankshaft bore surface 32. The connecting rod may be further defined by a beam 34 extending between the piston pin end and the crankshaft end.

The connecting rod may be rotationally coupled to the piston to form a piston and connecting rod assembly. The connecting rod may be coupled to the piston by way of a piston pin 36. The piston pin 36 may be inserted through the piston pin bosses 38 and received in the piston pin end 22 of the connecting rod thereby generally securing the connecting rod 20 to the piston 23

In an internal combustion engine, the connecting rods may transmit combustion power from the piston to the crankshaft of the engine, thereby converting the linear motion of the piston to rotational motion at the crankshaft. Combustion power is generated from the intermittent ignition of combustible fuel such as gasoline that is injected into the combustion chamber, which creates extreme pressures that are applied to the piston and the connecting rod.

In modern internal combustion engines, the piston is both thermally and mechanically loaded to a particular extent. This also applies to the piston skirt 16 and the running surfaces thereof, in particular during interaction between the piston running surface and a cylinder wall running surface. This results in fatigue of the running surfaces. In order to counteract this fatigue, it is known to provide the running surfaces with a coating that is intended to withstand the mechanical and thermal loads and improve the friction behavior of the piston with respect to the cylinder wall running surface.

Referring now to FIG. 2, which is an exemplary illustration of one method of applying an anti-friction coating. In one exemplary approach, it is contemplated than the anti-friction coating 50 is applied to at least a portion of the surface area of the part 10 or piston assembly. The anti-friction coating 50 is illustrated applied utilizing a controlled spray technique. In this exemplary embodiment, a spray assembly 52 is utilized to direct the anti-friction coating 50 onto the piston skirt 16. In other exemplary approaches, it is contemplated that the anti-friction coating 50 may be applied utilizing a silk screening process shown in FIG. 3. In this exemplary illustration, the anti-friction coating 50 is applied to the piston skirt 16 using a silk screening assembly 54.

It is contemplated that in one illustrative example, the anti-friction coating 50 may comprise a binder matrix and a solid lubricant. Examples of useful binder systems include, but are not limited to, polymers from the families polyamide-imide (“PAI”), polyetheretherketone (“PEEK”), polyetherketone (“PEK”), polyetherketoneketone (“PEKK”), polyaryletherketone (“PAEK”), and/or epoxy resins of different chemical formula, and/or any combinations of such materials. The solid lubricants may include examples such as hexagonal boron nitride (“hBN”), graphite, molybdenum disulfide (MoS₂), tungsten disulfide (WS₂), zinc sulfide (ZnS), PTFE.

In addition to a binder matrix and solid lubricant, the anti-friction coating 50 may also include hard particles as compared to the hardness of the binder matrix and solid lubricant to improve wear resistance. Some non-limiting examples may include tungsten carbide (WC), silicon carbide (SiC), silicon nitride (Si3N4), boron carbide (B₄C), cubic boron nitride (cBN), aluminum oxide (Al₂O₃), titanium dioxide (TiO₂), titanium nitride (TiN). Materials such as short carbon fibers may also be used in some embodiments. Additionally, reactive contributors, as only one example, zinc phosphate, may improve the sliding properties of such systems. Under certain conditions the reactive contributor can react on a chemical basis with a counterpart contributor to form a sliding component. For example, zinc phosphate can react with stearic acid (if present in the oil) to form zinc stearate.

In an exemplary approach, the anti-friction coating 50 is subjected to localized curing energy as is illustrated in FIG. 4. FIG. 4 illustrates the use of an infra-red radiation generator 60 utilizing a corresponding focus lens assembly 62 to direct infra-red radiation 64 to only a localized region of the piston 10. In the exemplary illustration, this localized region is the piston skirt 16. The infra-red radiation 64 generates regional curing thermal energy where it impacts the piston skirt 16 rather than heating the entire part. This allows a quicker and more precise control of the curing process. In one illustrative example the infra-red radiation 64 may be delivered in the form of a focused beam. In other approaches, it is contemplated that an infra-red laser may be utilized for even more precise control.

It is contemplated that one or more infra-red radiation generating components 60 may be utilized in combination (e.g., three such components illustrated as elements 60, 60′, and 60″). Each of these plurality of infra-red radiation generating components 60, 60′, 60″ may be selectively engaged such that varied portions of the part 10 may be cured in different fashions. This allows for the anti-friction coating to be cured in only selective areas, or to have varied curing properties across the exterior surface of the part 10. It is further contemplated that the anti-friction coating 50 may include metallic pigments or other particles that react to the infra-red radiation 64 in order to generate the regional curing thermal energy. The metallic pigments may include, but are not limited to, aluminum, copper, nickel, silver, stainless steel or any other flat shaped metallic alloys.

Although a single infra-red exposure may be sufficient to quickly cure the anti-friction coating 50, at least one exemplary embodiment contemplates the use of a plurality of different temperature/time ramps. It is contemplated that at least two temperature-steps are utilized such as a first step of 2 minutes at 100 C and a second step of 3 minutes at 230 C. This allows curing to be accomplished in considerably quicker times than conventional curing (hot air convection). In addition, since the exemplary illustration only generates regional curing thermal energy, as opposed to heating the entire part, curing may be more precisely controlled and more efficient.

In a similar fashion, it is contemplated that the infra-red radiation 64 may be substituted with other forms of curing radiation such as ultra-violet radiation as illustrated in FIG. 5. FIG. 5 illustrates an exemplary embodiment wherein an ultra-violet radiation generating component 70 focuses the ultra-violet 72 radiation on only a localized region of the piston 10 such as the skirt 16.

Additionally, another example contemplates the use of induction radiation to facilitate the generation of localized curing thermal energy as illustrated in FIG. 6. The induction assembly 70 includes an inner induction coil 72 and an outer induction coil 74. The piston 10 is arranged within the induction assembly 70 such that the localized regions where curing is desired are positioned between the inner induction coil 72 and the outer induction coil 74. In this fashion, localized regions may generate curing thermal energy without heating the entire part.

In an exemplary illustration, the individual curing methodologies described may be utilized in various combinations to generate unique curing profiles as well as simultaneously cure an anti-friction coating 50 with varied compositions in different locations of the piston 10. Therefore, the piston assembly 10 may be first subjected to curing via one type of curing energy (e.g., infra-red, ultra-violet or induction radiation) and then subsequently subjected to another of the curing techniques (e.g., a different form or application of radiation) or even conventional hot air curing. This allows a tailored curing profile to be performed on each localized region of the piston 10. A piston 10 treated in this fashion could have a different custom anti-friction coating 50 on each surface area that was particularly suited for that regions operational exposure.

Finally, the anti-friction coating 50 may be comprised of a variety of compositions and applied in different ranges of thicknesses. In several illustrations presented solely by way of example, it is contemplated the anti-friction coating 50 may comprise a coating layer having a thickness of approximately 5-40 μm. It is further contemplated that the compositions [MBS1] may be combined in a variety of ways such as:
PAI+Graphite+Al-Pigments
PAI+Graphite+MoS₂+Al-Pigments
PAI+PEEK+Graphite+WS₂
PAI+Graphite+MoS₂+Zn-Phosphate.

The following Table illustrates five sample recipes of an anti-friction coating 50 that are intended to be non-limiting. These recipes described herein and without disclaiming any other illustrative embodiments or subject matter:

| | | | | | | Reference |
|---|---|---|---|---|---|---|
| g per 100 g of | | | | | | (Grafal |
| material | 1 | 2 | 3 | 4 | 5 | 255) |
| PAI (Poly-amide- | 30-55 | 30-55 | 30-55 | 30-55 | 30-55 | 30-55 |
| imide) | | | | | | |
| Graphite | 15-20 | | | 5 | | 18-25 |
| Molybdenum | | 15-20 | 15-20 | 15 | | |
| disulfide | | | | | | |
| SiC/B₄C/WC | 5-10 | 5-10 | 5-10 | | 5 | |
| Aluminum oxide/ | | | 5 | 10 | 10 | |
| Nickel | | | | | | |
| Hexagonal boron | | | | | 15-20 | |
| nitride (hBN) | | | | | | |
| Zinc phosphate | | 5-10 | 5-10 | | | |
| NEP | 40-45 | 40-45 | 40-45 | 40-45 | | 45-50 |
| (N- | | | | | | |
| ethylpyrrolidone) | | | | | | |
| (as solvent) | | | | | | |

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A method of applying an anti-friction coating to a piston assembly, comprising:
applying an anti-friction coating to at least a portion of the surface area of a piston, said anti-friction coating comprising a binder matrix and a solid lubricant;
applying a localized curing energy to only a portion of said surface area, said localized curing energy comprising a first curing energy.

2. The method of claim 1, wherein said first curing energy comprises one of infra-red radiation, ultra-violet radiation, and induction radiation.

3. The method of claim 1, further comprising:
subjecting said piston to a second curing energy after applying said first curing energy.

4. The method of claim 3, wherein said second curing energy comprises hot air convection.

5. The method of claim 3, wherein said second curing energy comprises one of infra-red radiation, ultra-violet radiation, and inductive radiation.

6. The method of claim 1, wherein the binder matrix comprises a polymer matrix comprising one of polyamide-imide, polyetheretherketone, polyetherketone, polyetherketoneketone, polyaryletherketone and epoxy resin.

7. The method of claim 1, wherein said anti-friction coating further comprises metallic pigments.

8. The method of claim 7, wherein said metallic pigments react with said localized curing energy to generate regional curing thermal energy.

9. The method of claim 1, wherein said localized curing energy is applied utilizing a controlled beam.

10. The method of claim 1, wherein further comprising:
selecting at least one energy source from a plurality of curing energy sources to generate said localized curing energy.

11. The method of claim 1, wherein said anti-friction coating further comprises hard particles comprising one of tungsten carbide, silicon carbide, silicon nitride, boron carbide, cubic boron nitride, aluminum oxide, titanium dioxide and titanium nitride.

12. The method of claim 1, wherein said anti-friction coating further comprises at least one reactive component.

13. The method of claim 1, wherein said localized curing energy is applied in a plurality of temperature-time steps.

14. A method of applying an anti-friction coating to a part assembly, comprising:
applying an anti-friction coating to at least a portion of the surface area of a part, said anti-friction coating comprising a binder matrix and a solid lubricant;
applying a localized curing energy to only a portion of said surface area to generate regional curing thermal energy, said localized curing energy comprising a first curing energy.

15. The method of claim 14, wherein said first curing energy comprises one of infra-red radiation, ultra-violet radiation, and induction radiation.

16. The method of claim 14, further comprising:
subjecting said part to a second curing energy after applying said first curing energy.

17. The method of claim 15, wherein said second curing energy comprises one of infra-red radiation, ultra-violet radiation, inductive radiation, and hot air convection.

18. The method of claim 14, wherein said localized curing energy is applied utilizing a controlled beam.

19. A method of applying an anti-friction coating to a piston assembly, comprising:
applying an anti-friction coating to at least a portion of the surface area of a piston, said anti-friction coating comprising a binder matrix and a solid lubricant and metallic pigments;
applying a localized curing energy to only a portion of said surface area, said localized curing energy comprising one of infra-red radiation, ultra-violet radiation, and inductive radiation, said localized curing energy reacting with said metallic pigments to generate regional curing thermal energy.

20. The method of claim 19, wherein said localized curing energy is applied in a plurality of temperature-time steps.
